(19) United States
(12) Patent Application Publication
(10) Pub. No.: US 2026/0152961 A1
(43) Pub. Date: Jun. 4, 2026

(54) POOL ROBOT

(71) Applicant: XINGMAI INNOVATION TECHNOLOGY (SUZHOU) CO., LTD., Suzhou (CN)

(72) Inventor: Shilei ZHANG, Suzhou (CN)

(21) Appl. No.: 19/452,117

(22) Filed: Jan. 16, 2026

Related U.S. Application Data
(63) Continuation of application No. 19/323,814, filed on Sep. 9, 2025.
Application No. 19/323,814 is a continuation of application No. PCT/CN2023/116840, filed on Sep. 4, 2023.

(30) Foreign Application Priority Data
Mar. 20, 2023 (CN) 202310269067.4

(51) Int. Cl. E04H 4/16; A47L 11/40

(52) U.S. Cl. CPC E04H 4/1654; A47L 11/4027; A47L 11/4075; A47L 2201/00

(57) ABSTRACT

This application provides a pool robot including a housing, a filtering box, and a water baffle plate. The housing is provided with a first water outlet hole and an accommodation cavity. The filtering box is disposed in the accommodation cavity. A second water outlet hole is disposed on a side wall of the accommodation cavity. The water baffle plate is connected to a side of the side wall of the accommodation cavity and provided over the second water outlet hole, where the side of the side wall is away from the filtering box. When the pool robot is located in water, the water baffle plate closes the second water outlet hole. When the pool robot leaves the water, the water baffle plate is opened, and water in the filtering box is drained from the housing sequentially through the second water outlet hole and the first water outlet hole.

### CROSS REFERENCE TO RELATED APPLICATIONS

This application is a continuation of U.S. Patent Application No. 19/323,814, filed September 9, 2025 which is a Continuation of International Patent Application No. PCT/CN2023/116840, filed with the World Intellectual Property Organization on September 4, 2023, which claims priority to Chinese Patent Application No. 2023102690674, filed with the China National Intellectual Property Administration on March 20, 2023 and entitled "POOL ROBOT", which is incorporated herein by reference in its entirety.

### TECHNICAL FIELD

This application relates to the technical field of pool working devices, and in particular, to a pool robot.

### BACKGROUND

As an automatic device working in a pool, a pool robot can automatically complete work such as pool cleaning, thereby reducing time for a user. Therefore, the pool robot is widely praised by the user.

However, because the pool robot works in water, there are two common problems of the pool robot in the conventional technology, which greatly affect user experience but have not been resolved for a long time. First, when the pool robot is in water, there is a large amount of water inside the pool robot, so it is necessary to take significant effort to extract the pool robot from the water. Second, after the pool robot is extracted from a water surface, the water inside the pool robot needs to be drained, but a drainage speed is slow.

### SUMMARY

An objective of this application is to propose a pool robot, which can improve a drainage speed of the pool robot in a process of leaving water, quickly reduce a weight of the pool robot, and therefore help improve user experience.

To achieve the objective, this application uses the following technical solutions. A pool robot includes:

a housing, where a lower end surface of the housing is provided with a first water outlet hole, and the housing is provided with an accommodation cavity;

a filtering box disposed in the accommodation cavity, where a side wall of the

accommodation cavity is provided with a second water outlet hole; and

a water baffle plate, where a part of the water baffle plate is connected to a side of the side wall of the accommodation cavity, where the side of the side wall is away from the filtering box, the water baffle plate is provided over the second water outlet hole, when the pool robot is located in water, the water baffle plate closes the second water outlet hole, and in a process in which the pool robot is leaving the water, the water baffle plate is opened, and water in the filtering box flows out through the second water outlet hole and is drained from the housing through the first water outlet hole.

In an optional solution, the water baffle plate is made of a flexible waterproof material.

In an optional solution, when the pool robot is in water, the water baffle plate is attached to an outer side of the side wall under the action of water pressure inside and outside the second water outlet hole, so that the second water outlet hole is closed, and in the process in which the pool robot is leaving the water, the water baffle plate is located lower than the filtering box, and the water baffle plate is opened under a force of gravity.

In an optional solution, the water baffle plate includes:

a body provided over the second water outlet hole; and

a rotating shaft disposed between the side wall and the body, where the rotating shaft is located at an upper side of the second water outlet hole, and the body is rotatably connected to the rotating shaft.

In an optional solution, a surface area of the water baffle plate facing the second water outlet hole is greater than an area of the second water outlet hole, and a part of perimetrical boundary of the water baffle plate is connected to the side wall.

In an optional solution, the second water outlet hole is close to the lower end surface of the housing. In an optional solution, the pool robot further includes:

a filter member disposed on an inner wall of the filtering box, where the inner wall corresponds to the second water outlet hole.

In an optional solution, an area of the first water outlet hole ranges from 2000 mm² to 6000 mm². In an optional solution, the pool robot further includes:

a handle, where the handle is disposed at a front end of the housing, and when the handle is lifted, the side wall provided with the second water outlet hole tilts.

In an optional solution, in a state in which the handle is lifted, the first water outlet hole is close to a lowest point of the housing.

In an optional solution, when the handle is lifted, the lower end surface of the housing and a horizontal plane form an included angle of 45° to 75°.

In an optional solution, in a state in which the handle is lifted, the first water outlet hole is located lower than the second water outlet hole.

In an optional solution, the filtering box is provided with a liquid inlet and a liquid outlet, and the pool robot further includes:

a filter driving assembly, where the filter driving assembly is configured to drive the pool robot to suck water in a pool, the water enters the filtering box through the liquid inlet, garbage remains in the filtering box after the water is filtered by the filtering box, and the filtered water is drained from the liquid outlet.

In an optional solution, there are a plurality of first water outlet holes, and the plurality of first water outlet holes are provided in an array.

In an optional solution, there are a plurality of second water outlet holes, and the plurality of second water outlet holes are provided in an array.

A pool robot includes:

a housing, where a lower end surface of the housing is provided with a first water outlet hole, and the housing is provided with an accommodation cavity;

a filtering box disposed in the accommodation cavity, where a side wall of the accommodation cavity is provided with a second water outlet hole; and

a water baffle plate, where a part of the water baffle plate is connected to a side of the side wall of the accommodation cavity, where the side of the side wall is away from the filtering box, the water baffle plate is provided over the second water outlet hole, when water pressure inside the second water outlet hole is less than water pressure outside the housing, the water baffle plate is attached to the side of the side wall, where the side of the side wall is away from the filtering box, and when the water pressure inside the second water outlet hole is greater than the water pressure outside the housing, the water baffle plate is opened, and a part of the water baffle plate is opened under a force of gravity, where the part is not connected to the side wall, to be separated from the side wall to form a gap, so that water is capable of being quickly drained from the gap.

A pool robot includes:

a housing, where a lower end surface of the housing is provided with a first water outlet hole, and the housing is provided with an accommodation cavity;

a filtering box disposed in the accommodation cavity, where a side wall of the accommodation cavity is provided with a second water outlet hole; and

a water baffle plate, where a part of the water baffle plate is connected to a side of the side wall of the accommodation cavity, where the side of the side wall is away from the filtering box, the water baffle plate is provided over the second water outlet hole to close or open the second water outlet hole, and when the pool robot moves to a position at which the side wall tilts, the water baffle plate is opened, and water in the filtering box flows out through the second water outlet hole and is drained from the housing through the first water outlet hole.

### BRIEF DESCRIPTION OF DRAWINGS

To describe technical solutions in embodiments of this application more clearly, the following briefly introduces the accompanying drawings required for describing embodiments of this application. It is clear that the accompanying drawings in the following description show merely some embodiments of this application, and a person of ordinary skill in the art may still derive other drawings from the content of embodiments of this application and these accompanying drawings without creative efforts.

FIG. 1 is a diagram 1 of a cross-sectional structure of a pool robot according to an embodiment of this application;

FIG. 2 is a diagram 2 of a cross-sectional structure of a pool robot according to an embodiment of this application;

FIG. 3 is a diagram 1 of a structure of a pool robot according to an embodiment of this application; and

FIG. 4 is a diagram 2 of a structure of a pool robot according to an embodiment of this application.

Reference numerals:

100: housing; 110: first water outlet hole; 120: accommodation cavity; 130: second water outlet hole; 140: water inlet hole; 200: filtering box; 300: water baffle plate; 400: handle; 500: filter driving assembly.

### DESCRIPTION OF EMBODIMENTS

The following further describes this application with reference to the accompanying drawings and embodiments. It may be understood that the specific embodiments described herein are merely used to explain this application, but are not intended to limit this application. In addition, it should be noted that, for ease of description, only a part but not all of a structure related to this application is shown in the accompanying drawings.

In descriptions of this application, unless otherwise expressly specified and limited, the terms such as "link", "connect", and "fasten" should be understood broadly. For example, the term "connect" may indicate a fixed connection, a detachable connection, or an integral connection, may indicate a mechanical connection or an electrical connection, or may indicate a direct connection, an indirect connection implemented through an intermediate medium, or communication between internal structures of two elements or an interaction relationship between two elements. A person of ordinary skill in the art may understand specific meanings of the foregoing terms in this application based on a specific situation.

In this application, unless otherwise expressly specified and limited, that a first feature is "above" or "below" a second feature may be that the first feature may be in direct contact with the second feature, or the first feature may be in contact with the second feature through another feature between the first feature and the second feature instead of being in direct contact with the second feature. In addition, that the first feature is "above", "on", or "over" the second feature may be that the first feature is right above or obliquely above the second feature, or merely mean that a horizontal height of the first feature is greater than that of the second feature. That the first feature is "below", "underneath", or "under" the second feature may be that the first feature is right below or obliquely below the second feature, or merely mean that a horizontal height of the first feature is less than that of the second feature.

In descriptions of embodiments, an orientation or position relationship indicated by terms "above", "below", "left", "right", and the like is an orientation or position relationship based on the accompanying drawings, and is only intended to facilitate descriptions and simplify operations, but is not intended to indicate or imply that an apparatus or an element needs to have a specific orientation and be constructed and operated in a specific orientation. Therefore, such terms cannot be understood as a limitation on this application. In addition, the terms "first" and "second" are merely used to distinguish in description and have no special meaning.

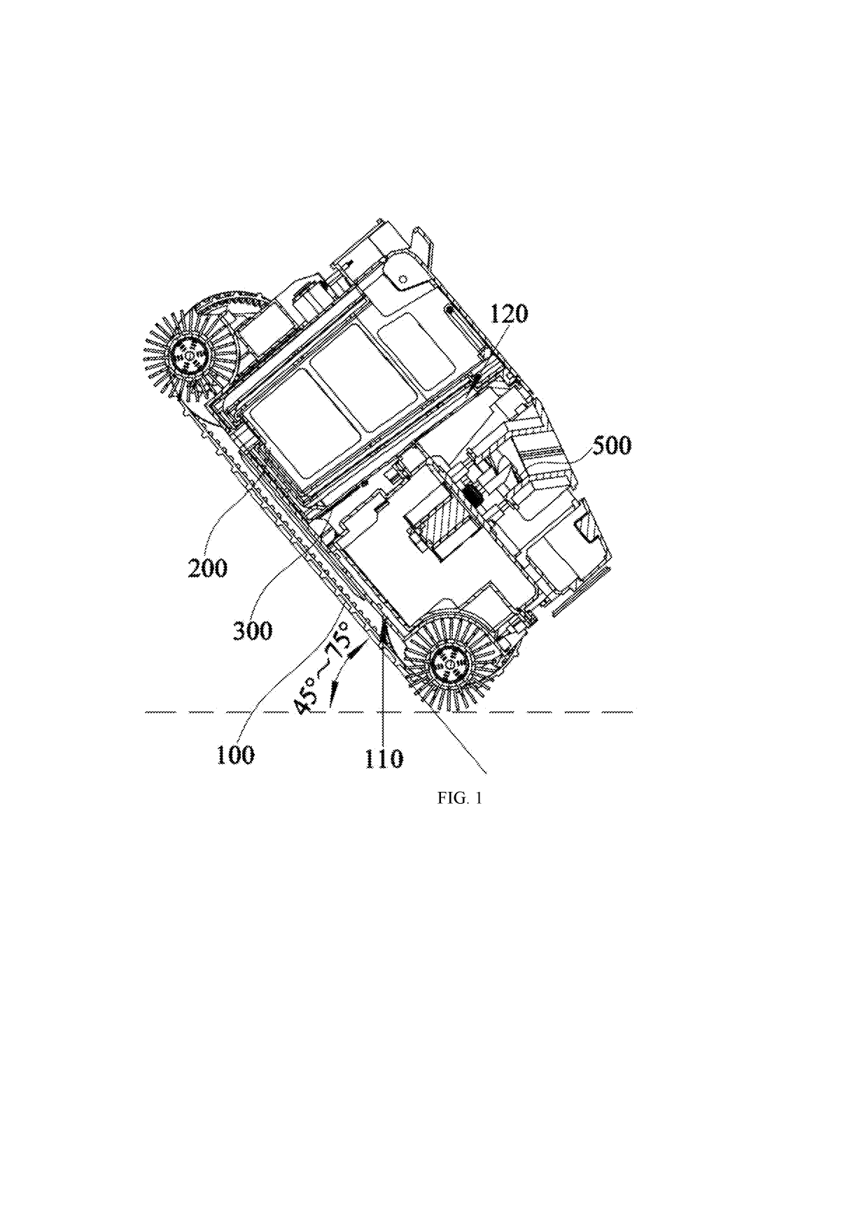

As shown in FIG. 1 to FIG. 4, an embodiment provides a pool robot, and the pool robot works in a pool. Currently, a commonly used pool robot is mainly configured to clean a bottom surface and a wall surface of a pool. The pool robot includes a housing 100 and a filtering box 200. The housing 100 is provided with an accommodation cavity 120. The filtering box 200 is disposed in the accommodation cavity 120. The pool robot further includes a filter driving assembly 500. The filtering box 200 is provided with a liquid inlet and a liquid outlet. The filter driving assembly 500 can drive the pool robot to suck water in the pool. The water enters the filtering box 200 through the liquid inlet, garbage remains in the filtering box 200 after the water is filtered by the filtering box 200, and cleaned liquid is drained from the liquid outlet.

When the pool robot works in water, water enters the housing 100 through various gaps on the housing 100. Therefore, a large amount of water remains inside a body of the pool robot. When a user lifts the pool robot out of a water surface, a weight of the pool robot is large due to a weight of the water in the housing 100, and the user needs to take significant effort to lift the body out of the water surface. After the body is lifted out of the water surface, due to a slow drainage speed of the housing 100, it takes a long time to completely drain the water in the housing 100, which is time-consuming and poor in user experience.

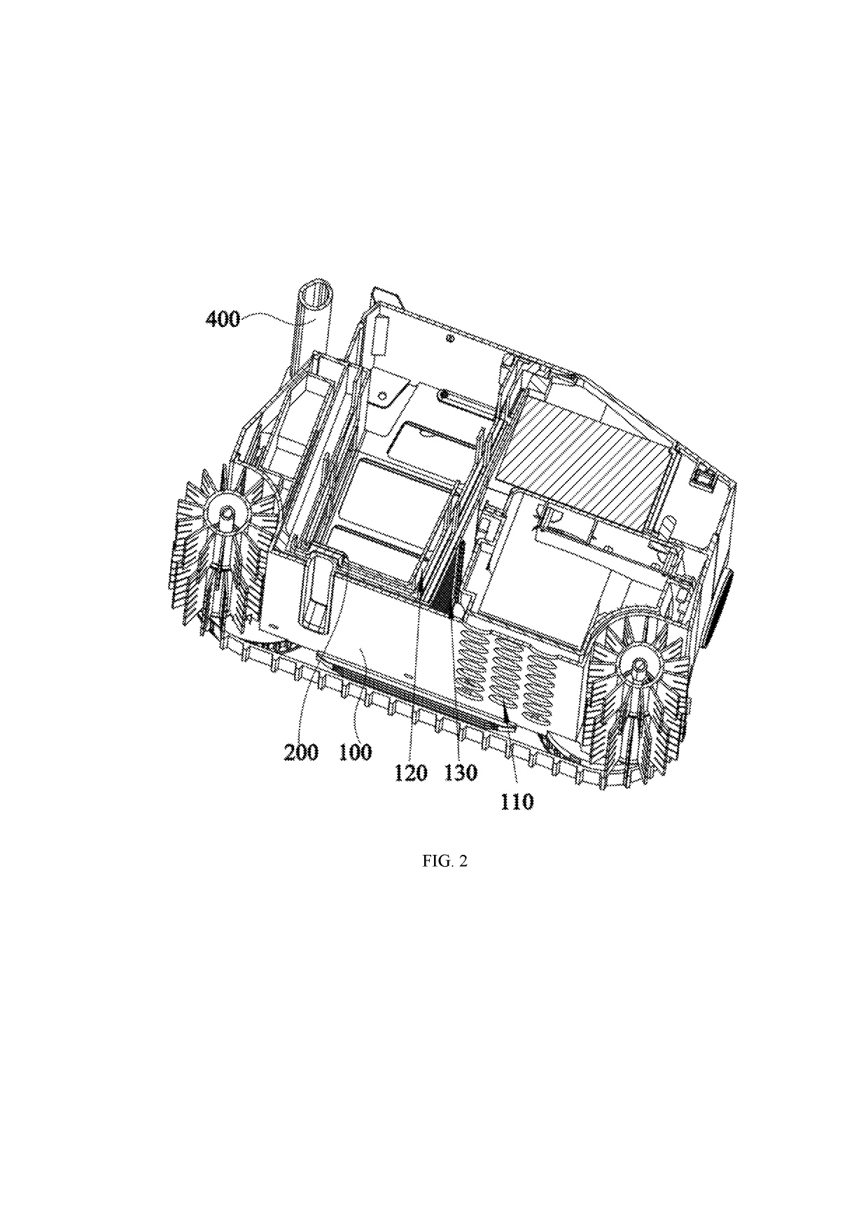

As shown in FIG. 1 and FIG. 2, in this embodiment, a lower end surface of the housing 100 is provided with a first water outlet hole 110, so that the water inside the housing 100 can be quickly drained from the first water outlet hole 110 in or after a process in which the pool robot is leaving the water (that is, leaving the water surface). A side wall of the accommodation cavity 120 is provided with a second water outlet hole 130. The pool robot further includes a water baffle plate 300. A part of the water baffle plate 300 is connected to a side of the side wall of the accommodation cavity 120, and the side of the side wall is away from the filtering box 200, that is, the water baffle plate 300 is partially connected to the side of the side wall of the accommodation cavity 120, and the side of the side wall is away from the filtering box 200. The water baffle plate 300 is provided over the second water outlet hole 130. When the pool robot is located in water, the water baffle plate 300 closes the second water outlet hole 130 to avoid the following case: Water enters the filtering box 200 through the second water outlet hole 130, affecting working efficiency of the pool robot. In or after the process in which the pool robot is leaving the water (that is, leaving the water surface), the water baffle plate 300 is opened, and water in the filtering box 200 can flow out through the second water outlet hole 130 and be drained from the housing 100 through the first water outlet hole 110, so that the water in the filtering box 200 is quickly drained. This improves a drainage speed of the pool robot in the process of leaving the water, quickly reduces the weight of the pool robot, and therefore helps improve user experience. In a process in which the pool robot enters the water, the water can enter the inside of the housing 100 through the first water outlet hole 110. This helps quickly increase the weight of the pool robot, so that the pool robot quickly enters the water, and therefore improves water entry efficiency of the pool robot.

Optionally, the water baffle plate 300 is made of a flexible waterproof material. When the pool robot is in water, the water baffle plate 300 can be attached to an outer side of the side wall under the action of water pressure inside and outside the second water outlet hole 130, so that the water in the filtering box 200 does not flow out through the second water outlet hole 130, and outside water cannot enter through the second water outlet hole 130. When the pool robot leaves the water, because the water outside the filtering box 200 is quickly drained from the first water outlet hole 110, pressure outside the filtering box 200 decreases, and a part of the water baffle plate 300 is opened under a force of gravity, where the part is not connected to the side wall, to be separated from the side wall to form a gap, so that the water is capable of being quickly drained from the gap. The water baffle plate 300 can selectively close the second water outlet hole 130 without any additional driving force. This can reduce costs and help simplify a structure of the pool robot.

In other embodiments, the water baffle plate 300 includes a body and a rotating shaft. The body is provided over the second water outlet hole 130, the rotating shaft is disposed between the side wall and the body, and the rotating shaft is located at an upper side of the second water outlet hole 130. The body is rotatably connected to the rotating shaft, so that when the pool robot leaves the water, the body can be driven to rotate under a force of gravity of the water to open the second water outlet hole 130. It should be noted that "above" herein indicates a side of the pool robot and away from the ground when the pool robot is located on the ground.

Optionally, a surface area of the water baffle plate 300 facing the second water outlet hole 130 is greater than an area of the second water outlet hole 130, so that the water baffle plate 300 can fully cover the second water outlet hole 130. Optionally, a part of perimetrical boundary of the water baffle plate 300 is connected to the side wall, that is, the perimetrical boundary of the water baffle plate 300 is intermittently connected to the side wall, so that after the pool robot leaves the water, the water in the filtering box 200 can overflow from the part of the water baffle plate 300, where the part is not connected to the side wall. Specifically, that the perimetrical boundary of the water baffle plate 300 is intermittently connected to the side wall may be that each side of the water baffle plate 300 is partially connected to the side wall, so that when the pool robot is located underwater, the water in the filtering box 200 is prevented from flowing out through the second water outlet hole 130 by using water pressure outside the side wall. However, after the pool robot leaves the water surface, the water pressure outside the water baffle plate 300 disappears. In this case, under the action of water pressure inside the filtering box 200, the part of the water baffle plate 300, where the part is not connected to the side wall, is driven to be separated from the side wall, so that the water in the filtering box 200 can flow out through the second water outlet hole 130. Certainly, that the perimetrical boundary of the water baffle plate 300 is intermittently connected to the side wall may alternatively be that at least one side of the water baffle plate 300 is connected to the side wall, the side includes at least an upper side of the water baffle plate 300, and the upper side is away from the ground, so that when the pool robot leaves the water, the side of the water baffle plate 300, where the side is not connected to the side wall, can be separated from the side wall to open the second water outlet hole 130. This helps quickly drain water and therefore ensures drainage efficiency.

In addition, as shown in FIG. 1 and FIG. 2, the second water outlet hole 130 is provided close to the lower end surface of the housing 100, so that the water in the filtering box 200 can be fully drained, and residues are reduced.

Optionally, there are a plurality of first water outlet holes 110, and the plurality of first water outlet holes 110 are provided in an array. There are a plurality of second water outlet holes 130, and the plurality of second water outlet holes 130 are arranged in an array. This helps expand a drainage area and ensure drainage stability. Optionally, the first water outlet hole 110 and the second water outlet hole 130 are circular holes or grid holes.

Optionally, the pool robot further includes a filter member. The filter member is disposed on an inner wall of the filtering box 200, and the inner wall corresponds to the second water outlet hole 130, to prevent garbage in the filtering box 200 from being carried out during drainage.

Optionally, an area of the first water outlet hole 110 ranges from 2000 mm² to 6000 mm², thereby ensuring a sufficient drainage area and improving drainage efficiency.

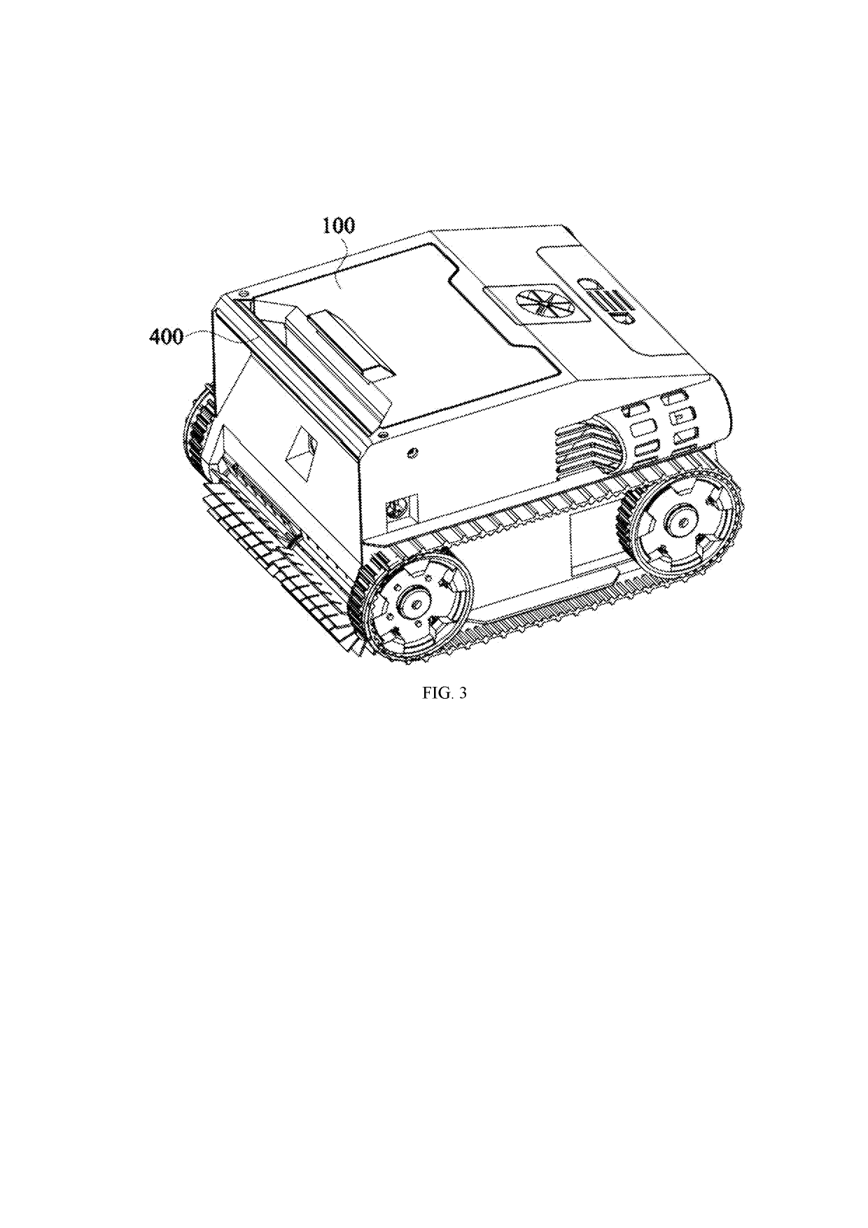

As shown in FIG. 2 and FIG. 3, the pool robot further includes a handle 400 disposed at a front end of the housing 100. This is convenient for a user to hold the pool robot. When the handle 400 is lifted, the side wall provided with the second water outlet hole 130 tilts. It should be noted that the front end is an end located in the front when the pool robot moves forward. In this way, liquid in the filtering box 200 is drained from the second water outlet hole 130 under a force of gravity. This can not only ensure the drainage efficiency, but also improve a drainage proportion, thereby preventing water from remaining in the filtering box 200.

In addition, to fully drain the water inside the housing 100, an internal structure of the pool robot does not have an obvious right angle or dead angle. This prevents the internal water from remaining and not being fully drained for a long time. Optionally, when the handle 400 is lifted, the lower end surface of the housing 100 and a horizontal plane form an included angle of 45° to 75°, so that the water naturally flows out under a force of gravity. This helps increase the drainage proportion. In this embodiment, in a state in which the handle 400 is lifted, the lower end surface of the housing 100 and a horizontal plane form the included angle of 45°.

In this embodiment, in a state in which the handle 400 is lifted, the first water outlet hole 110 is close to a lowest point of the housing 100. Because the water flows downward under a force of gravity when the user holds the handle 400 and lifts the pool robot, the first water outlet hole 110 is provided close to the lowest point of the housing 100 when the user holds the handle 400. This helps reduce water remaining inside the housing 100 and improve the drainage proportion.

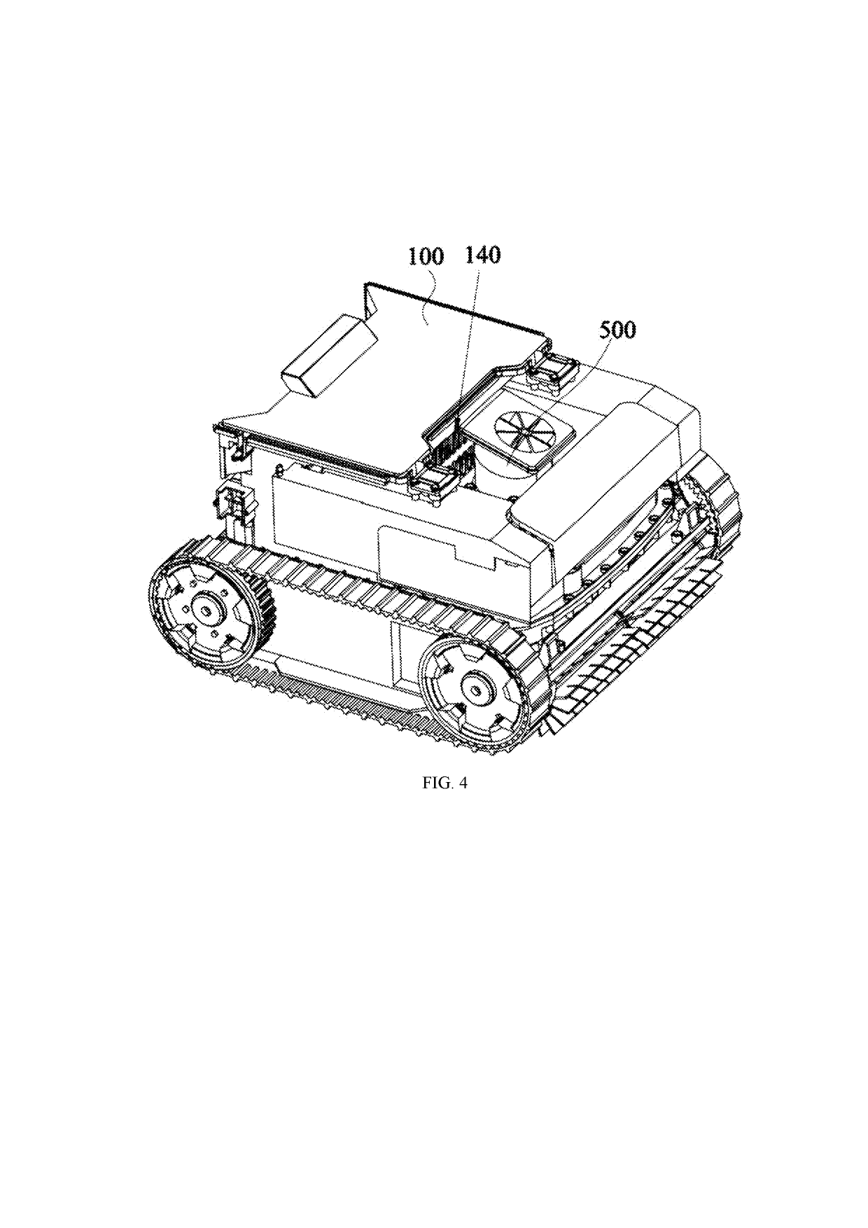

Refer to FIG. 4. Side walls of the filtering box 200 and the accommodation cavity 120 are each provided with a water inlet hole 140. The water inlet hole 140 is provided close to an upper end surface of the housing 100. When the pool robot enters water, water outside the housing 100 can enter the filtering box 200 through the water inlet hole 140. This helps quickly increase the weight of the pool robot, so that the pool robot quickly enters the water, and therefore improves the water entry efficiency of the pool robot.

Optionally, the water inlet hole 140 is a grid hole, and an opening area of the grid hole is large. This helps improve the water entry efficiency.

It can be understood that at least a part of the filter driving assembly 500 is disposed outside the water inlet hole 140. When the pool robot works in water, the filter driving assembly 500 can drive water and garbage to enter the liquid inlet of the filtering box 200. After the water and the garbage are filtered by the filtering box 200, the garbage remains in the filtering box 200, and the water is drained to the filter driving assembly 500 through the liquid outlet and the water inlet hole 140, and then is drained from the housing 100 along a preset path.

It should be noted that the foregoing shows and describes basic principles and main features of this application and advantages of this application. A person skilled in the art should understand that this application is not limited to the forgoing embodiments, the foregoing embodiments and this specification only describe principles of this application, and various changes and modifications may be made to this application without departing from the spirit and scope of this application. These changes and modifications fall within the protection scope claimed in this application. The protection scope claimed in this application is defined by the appended claims and equivalents thereof.

1. A pool cleaning robot, comprising:
a housing;
an accommodation cavity provided in the housing to receive a filtering box, the accommodation cavity is close to a front end of the housing and is formed by an inner surface of a plurality of walls, an outer surface of the plurality of walls and the housing form at least one chamber, the at least one chamber comprises a first chamber that is close to a rear end of the housing;
the plurality of walls comprises a first wall provided with a water inlet hole, a filter driving assembly is located in the first chamber and is in fluid communication with the accommodation cavity through the water inlet hole,
wherein the filter driving assembly is configured to drive water to flow into the filtering box and flow into the accommodation cavity, then enter the first chamber through the water inlet hole, and finally flow outside of the housing from the first chamber.

2. The pool cleaning robot according to claim 1, the plurality of walls comprises a second wall, the filtering box is located between the second wall and the filter driving assembly, the first chamber is formed by an outer surface of the first wall and an inner space of the housing.

3. The pool cleaning robot according to claim 2, further comprising a second chamber formed by the second wall and a front portion of the housing.

4. The pool cleaning robot according to claim 3, wherein the second wall is configured to block water in the second chamber from directly entering the filtering box.

5. The pool cleaning robot according to claim 3, a volume of the accommodation cavity or a volume of the filtering box is not larger than a volume of the first chamber and a volume of the second chamber.

6. The pool cleaning robot according to claim 3, wherein the filter driving assembly and the second chamber are not interconnected.

7. The pool cleaning robot according to claim 1, wherein the accommodation cavity is provided with a first opening, the first opening is interconnected with the water inlet through a water guiding duct.

8. The pool cleaning robot according to claim 7, wherein at least a part of the water guiding duct is outside the accommodation cavity.

9. The pool cleaning robot according to claim 7, wherein the filtering box has a second opening, the second opening is interconnected with the first opening.

10. The pool cleaning robot according to claim 1, wherein at least a part of the filter driving assembly closes to the water inlet hole.

11. The pool cleaning robot according to claim 1, the pool cleaning robot further comprising a container provided in the first chamber, the filter driving assembly comprising a motor provided in the container and a impeller provided outside of the container and connected with the motor.

12. The pool cleaning robot according to claim 11, the impeller is closer to a top of the water inlet hole than the motor.

13. The pool cleaning robot according to claim 1, the first chamber is closer to the end of the housing than the accommodation cavity or the filtering box.

14. The pool cleaning robot according to claim 1, the pool cleaning robot further comprising:
a water inlet provided at a bottom of the housing; and
a water outlet provided at a top of the housing;
wherein, the filter driving assembly drives water to flow into the housing through the water inlet, flow through the filtering box, the accommodation cavity and the first chamber, and then flow outside of the housing through the water outlet.

15. The pool cleaning robot according to claim 1, the pool cleaning robot further comprising:
at least one first water outlet hole provided on the housing;
at least one second water outlet hole provided on one of the plurality of walls of the accommodation cavity; and
a handle disposed at the front end of the housing,
when the handle is lifted, the wall provided with the second water outlet hole tilts, the at least one first water outlet hole is located lower than the at least one second water outlet hole, so that the filtering box, the accommodation cavity, the at least one second water outlet hole, and the at least one first water outlet hole are sequentially in fluid communication to form a water flow path to allow water in the housing to be quickly drained from the housing.

16. The pool robot according to claim 15, further comprising a water baffle plate provided over the at least one second water outlet hole, wherein a part of the water baffle plate is connected to one of the plurality of walls of the accommodation cavity,
when the pool robot is located in the water, the water baffle plate closes the at least one second water outlet hole, and in the process in which the pool robot is leaving the water, the part of the water baffle plate is opened under a force of gravity of water and form a gap with the wall of the accommodation cavity, so that water is capable of being quickly drained from the gap.

17. The pool robot according to claim 15, an area of the first water outlet hole ranges from 2000 mm² to 6000 mm².

18. A pool cleaning robot, comprising:
a housing;
an accommodation cavity provided in the housing to receive a filtering box, the accommodation cavity is close to an end of the housing and is formed by a plurality of walls, the plurality of walls and the housing form at least one chamber, the at least one chamber comprises a first chamber that is close to an another end of the housing;
the plurality of walls comprises a first wall provided with a water inlet hole, a filter driving assembly is located in the first chamber and is in fluid communication with the accommodation cavity through the water inlet hole,
wherein the filter driving assembly is configured to drive water to flow into the filtering box and flow into the accommodation cavity, then enter the first chamber through the water inlet hole, and finally flow outside of the housing from the first chamber.

19. The pool cleaning robot according to claim 18, the plurality of walls comprises:
a first wall provided with a water inlet hole, the first chamber is formed by an outer surface of the first wall and an inner space of the housing; and
a second wall, the second wall and a front portion of the housing form a second chamber.

20. The pool cleaning robot according to claim 19, a volume of the accommodation cavity or a volume of the filtering box is not larger than a volume of the first chamber and a volume of the second chamber.
